(19) United States
(12) Patent Application Publication
(10) Pub. No.: US 2018/0351688 A1
(43) Pub. Date: Dec. 6, 2018

(54) Use of Cinder Block or Concrete to Re-Radiate an RF Signal

(71) Applicants: John S. Cooper, JR., Melbourne Beach, FL (US); James A. Xanthos, Fulton, MD (US)

(72) Inventors: John S. Cooper, JR., Melbourne Beach, FL (US); James A. Xanthos, Fulton, MD (US)

(73) Assignee: J3 Technology LLC, Indialantic, FL (US)

(21) Appl. No.: 15/614,195

(22) Filed: Jun. 5, 2017

(51) Int. Cl. H04K 3/00; H04L 1/00; H04B 7/155; H04B 7/024; H04B 7/0491

(52) U.S. Cl. CPC H04K 3/42; H04K 3/43; H04B 7/0491; H04B 7/15592; H04B 7/024; H04L 1/0006

(57) ABSTRACT

A communication system is provided for use of cinder block to re-radiate an RF signal. The system overcomes the limitations of prior art techniques which attempt to work either through or around the cinder block or concrete as an RF obstruction.

In contrast, the system of the present invention uses the cinder block as a re-radiator for the RF signal. Although cinder block or concrete (such as a cinder block or concrete wall) has been described as the building material used to re-radiate, it is understood by those of ordinary skill in the art that the same technique can be used with building materials other than cinder block (e.g., concrete or other materials instead of cinder block).

The system is particularly useful when deployed in a MAS system or a jamming system in a prison environment. In this type of deployment, the cinder block or concrete can either be used to re-radiate TX signals from a BTS system or to re-radiate jamming signals from a jammer. The cinder block or concrete can also be used with an associated main receive antenna to improve signal reception.

### CROSS-REFERENCES TO RELATED APPLICATIONS

None

### BACKGROUND OF THE INVENTION

### a) Field of the Invention

The invention relates to the use of cinderblock or concrete to re-radiate an RF signal.

### b) Description of Related Art

In communication systems, transmitted RF signals tend to lose power as they travel farther away from the TX source. Part of this power loss is due to free space path loss and typically follows a reduction equation referred to as the inverse square law. Another cause of transmitted signal power loss is due to any impediments, beyond free space, that may exist between the TX source and the receiver. For example, if a large cinder block or concrete wall exists between the TX source and the receiver, the wall will cause an additional TX signal power loss above that caused by free space path loss alone.

Another significant factor when determining received signal power is multipath. Multipath is caused when a transmitted signal takes more than one path to a receive antenna based on reflections, such as reflections off the ground or a wall. When the signals arrive at the receive antenna from the various paths, the composite signal, composed of the addition of the signals from different paths, can either undergo constructive or destructive interference. The result of this addition depends on the phase of the signals from the various paths relative to each other.

In an environment that uses a Distributed Antenna System (DAS) to distribute TX signals throughout a given area, the impact of all of these factors must be considered. The impact of large impediments, such as cinder block or concrete walls, which can greatly reduce TX signal strength (typically 15-25 dB depending on the width and nature of the cinder block or concrete) is particularly challenging.

The prior art shows a variety of attempts in DAS systems to address the effects of signal reduction due to cinder block or concrete.

One technique is to simply increase the TX source power in order to overcome the potential attenuation caused by the cinder block or concrete wall or other impediment. Unfortunately, this technique has limited usefulness because the power levels required to increase the TX power by 15-25 dB cause the DAS transmitter modules to require very large power amplifiers. As an example, assume that a DAS system has been designed with a 5 Watt TX amplifier in order to achieve a certain radius of effectiveness in free space. If a cinder block or concrete wall with 20 dB of attenuation is introduced in to the situation, then the DAS transmitter will require a 500 Watt amplifier in order to achieve the same radius of effectiveness. This technique is not effective in the real world because of the increased cost, increased complexity, and decreased reliability of the resultant DAS system.

Another technique is to decrease the effective radius of the DAS system transmitters and just add more transmitters to achieve the same affect. This approach can also be examined using the 20 dB cinder block or concrete attenuation that was used in the previous example. Using the inverse square law, if the cinder block or concrete wall attenuates by 20 dB, then the effective radius is decreased by a factor of 10. As an example, if a DAS system has been designed with an effective radius of 100 feet, then in order to overcome the cinder block or concrete wall obstacle the new effective radius is 10 feet. This technique is not effective in the real world because of the increased cost, increased complexity, and decreased reliability of the resultant DAS system.

A third technique is to place the DAS antenna on the other side of the cinder block or concrete wall in order to avoid the impact of attenuation caused by the wall. The effectiveness of this technique depends on the topography of the area to be covered. If there is a single cinder block or concrete wall, then the technique has some merit. However, in an environment with many cinder block or concrete walls and many enclosed spaces (e.g., a prison facility), this technique suffers from many of the same limitations as the previous prior art techniques.

Furthermore, if a DAS is used as part of a Managed Access Service (MAS) system in a prison facility to prevent cellphone usage, then this third technique is not really viable. A MAS system is used in a prison facility to enable a series of local base stations (BTS) to capture all of the phones in the covered area in order to prevent the phones from connecting to the carrier macro network to place calls. If the DAS portion of the MAS system requires that the DAS antenna be placed within the prisoner's cell in order to provide an appropriate RF signal level, then the system will be vulnerable to attack and disablement by the prisoner residing in the cell.

All of the prior art techniques in DAS systems to address the effects of TX signal reduction due to cinder block or concrete have limitations that greatly reduce their viability in a real world system. This is especially the case when introduced in a MAS system in a prison facility.

### SUMMARY OF THE INVENTION

The object of the invention relates to a system for the use of cinder block or concrete to re-radiate an RF signal. The system overcomes the limitations of prior art techniques which attempt to work either through or around the cinder block or concrete as an RF obstruction.

The object is attained in a preferred embodiment of the invention having a communication system comprising a transmitter coupled to an antenna which is further coupled to cinder block or concrete for re-radiation of the transmit signal. The system may also include an external transmitter.

In a further embodiment of the invention, the communication system comprises a transmitter coupled to an RF element, which is further coupled to at least two antennas. Each of the antennas is respectively coupled to cinder block or concrete for re-radiating the transmit signal. The system may also include an external transmitter.

In another embodiment of the invention, the communication system comprises a transceiver coupled to an antenna which is further coupled to cinder block or concrete for re-radiation of the transmit signal to a further transceiver. The system may also include an external transmitter.

In a further embodiment of the invention, the communication system comprises a transceiver coupled to an RF element, which is further coupled to at least two antennas. Each of the antennas is respectively coupled to cinder block or concrete for re-radiating the transmit signal to a further transceiver. The system may also include an external transmitter.

Advantageous embodiments of the invention, with useful features and improvements of the invention, are described in more detail below.

### BRIEF DESCRIPTION OF THE DRAWINGS

The invention is described in detail below by way of preferred embodiments shown in the drawings.

FIG. 1 is a drawing showing a transmitter coupled to an antenna which is further coupled to cinder block or concrete for re-radiation of the transmit signal. The transmit signal is received by at least one receiver;

FIG. 2 is a drawing showing a transmitter, coupled to a switch, which is further coupled to at least two antennas for switching the transmit signal to one of the antennas. The antennas are further coupled to cinder block or concrete for re-radiation of the transmit signal. The transmit signal is received by at least one receiver;

FIG. 3 is a drawing similar to FIG. 1 with a transceiver on the communication link;

FIG. 4 is a drawing similar to FIG. 2 with a transceiver on the communication link;

FIG. 5 is a drawing similar to FIG. 1 with the addition of an external transmit signal generated by an external transmitter;

FIG. 6 is a drawing similar to FIG. 2 with the addition of an external transmit signal generated by an external transmitter;

FIG. 7 is a drawing similar to FIG. 3 with the addition of an external transmit signal generated by an external transmitter;

FIG. 8 is a drawing similar to FIG. 4 with the addition of an external transmit signal generated by an external transmitter.

### DETAILED DESCRIPTION OF THE PREFERRED EMBODIMENTS

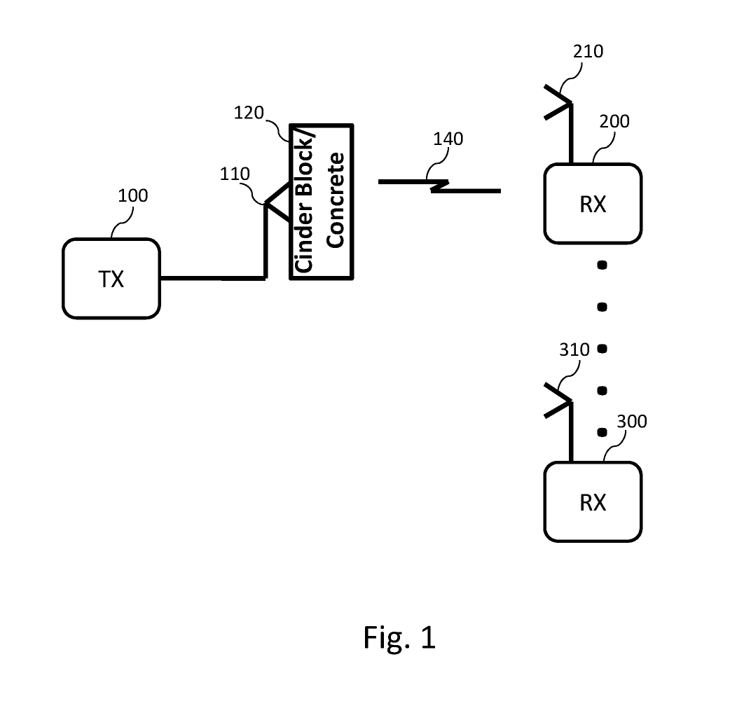

Referring to FIGS. 1-8, a system for the use of cinder block or concrete to re-radiate an RF signal will now be described with several preferred embodiments. It is understood that the embodiments described herein do not limit the scope of the invention, but merely provide examples of the present invention as used in several different instances.

FIG. 1 shows a communication system comprising a transmitter 100 coupled to an antenna 110, which is further coupled to cinder block/concrete 120 (such as a cinder block/concrete wall) for re-radiating the transmit signal 140. The transmit signal 140 is received by at least one receiver 200 & 300 through respective receive antennas 210 & 310.

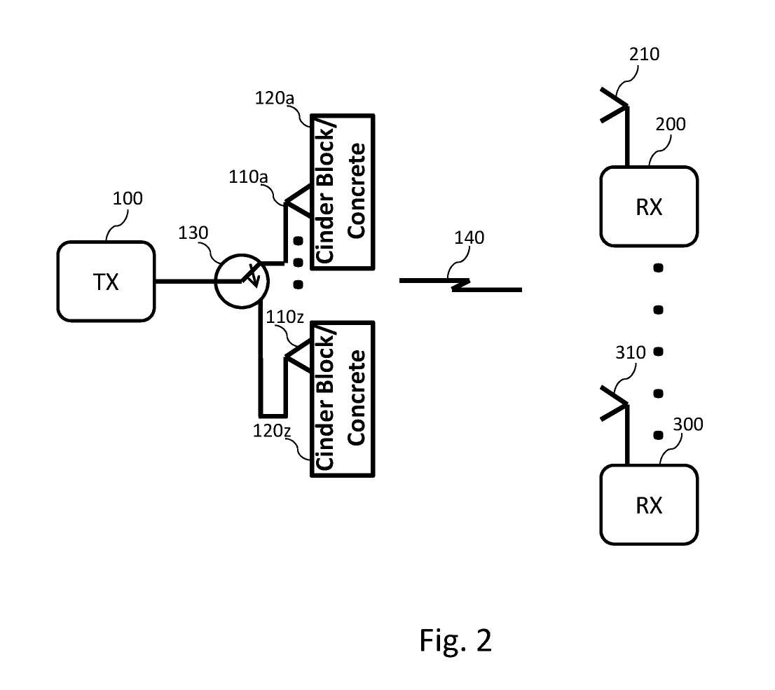

FIG. 2 shows a communication system comprising a transmitter 100 coupled to an RF element 130, which is further coupled to at least two antennas 110a & 110z. Each of the antennas 110a & 110z is respectively coupled to cinder block/concrete 120a & 120z for re-radiating the transmit signal 140. The transmit signal 140 is received by at least one receiver 200 & 300 through respective receive antennas 210 & 310.

The RF element 130 can be an RF switch which is switched periodically. Alternatively, RF element 130 can be an RF splitter that provides splitting of the RF signal to antennas 110a & 110z.

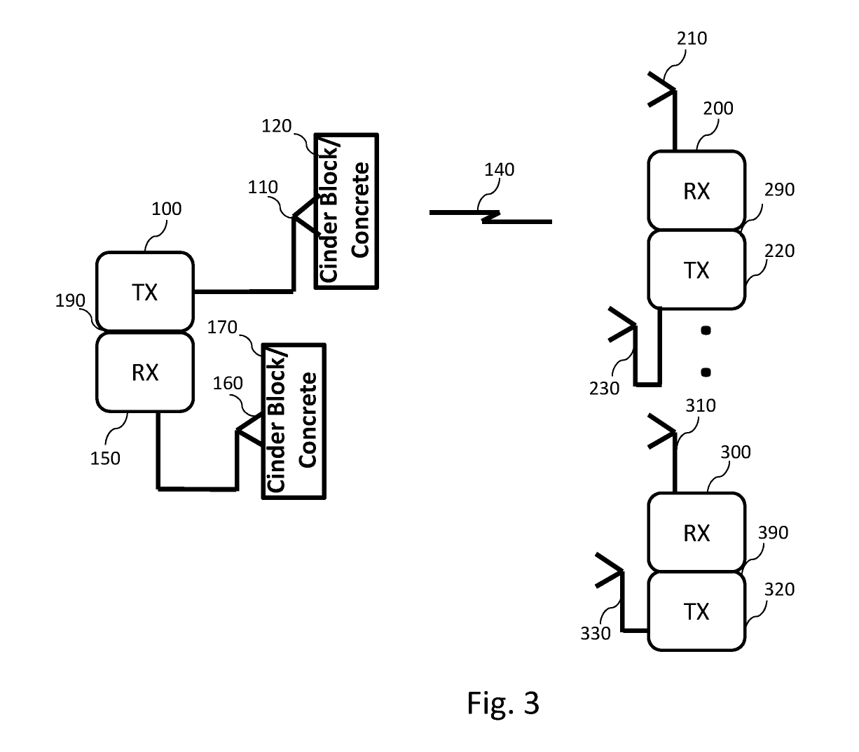

FIG. 3 shows a communication system comprising a first transceiver 190 with the associated transmitter 100 coupled to an antenna 110, which is further coupled to cinder block/concrete 120 (such as a cinder block/concrete wall) for re-radiating the transmit signal 140. The first transceiver 190 further includes a main receiver 150 coupled to a main receive antenna 160, which is further coupled to cinder block/concrete 170. The transmit signal 140 is received by at least one secondary transceiver 290 and 390. The secondary transceiver 290 and 390 include a respective secondary receiver 200 & 300 coupled to respective further antennas 210 & 310 to receive transmit signal 140. The secondary transceiver 290 and 390 further include a respective secondary transmitter 220 & 320 coupled to respective further antennas 230 & 330.

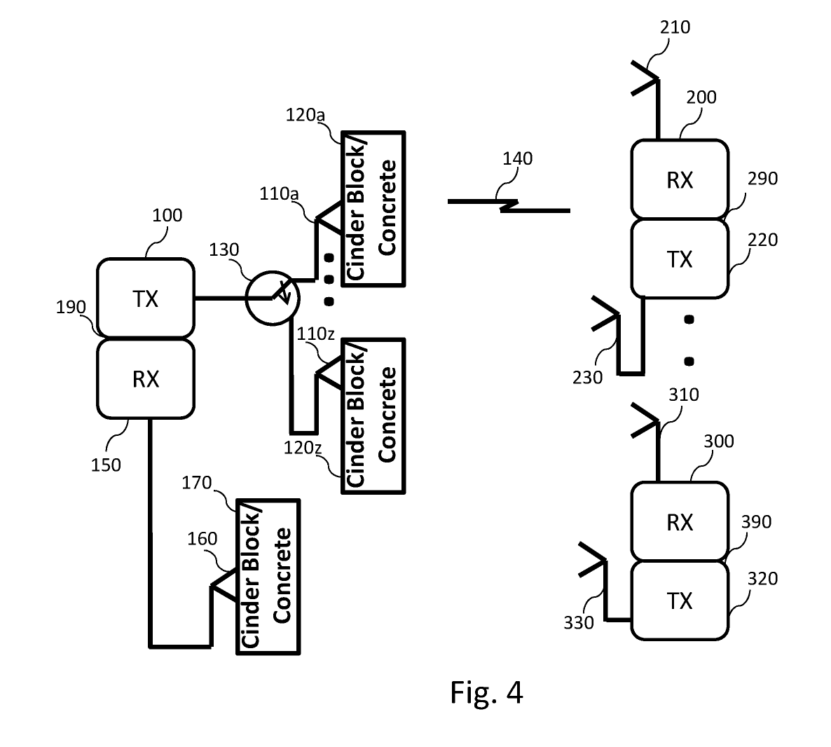

FIG. 4 shows a communication system comprising a first transceiver 190 with the associated transmitter 100 coupled to an RF element 130, which is further coupled to at least two antennas 110a & 110z. Each of the antennas 110a & 110z is respectively coupled to cinder block/concrete 120a & 120z for re-radiating the transmit signal 140. The first transceiver 190 further includes a main receiver 150 coupled to a main receive antenna 160, which is further coupled to cinder block/concrete 170. The transmit signal 140 is received by at least one secondary transceiver 290 and 390. The secondary transceiver 290 and 390 include a respective secondary receiver 200 & 300 coupled to respective further antennas 210 & 310 to receive transmit signal 140. The secondary transceiver 290 and 390 further include a respective secondary transmitter 220 & 320 coupled to respective further antennas 230 & 330.

The RF element 130 can be an RF switch which is switched periodically. Alternatively, RF element 130 can be an RF splitter that provides splitting of the RF signal to antennas 110a & 110z.

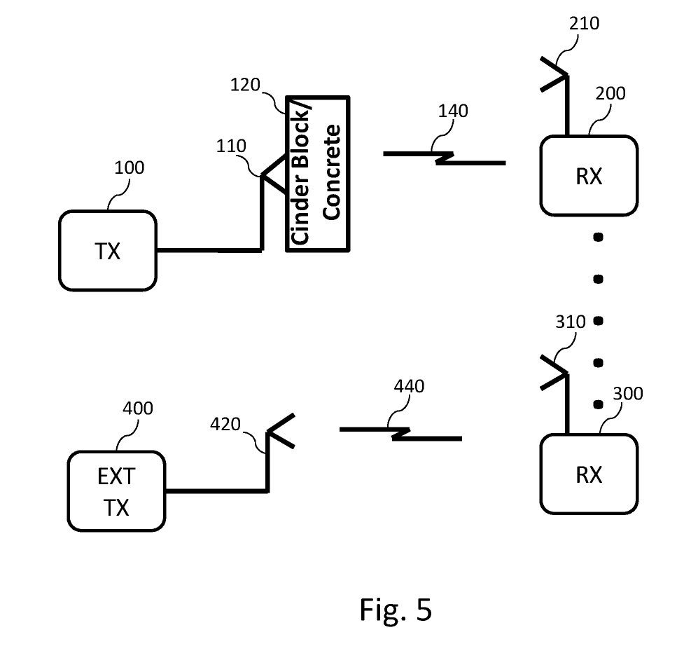

FIG. 5 shows a communication system comprising a transmitter 100 coupled to an antenna 110, which is further coupled to cinder block/concrete 120 (such as a cinder block/concrete wall) for re-radiating the transmit signal 140. The transmit signal 140 is received by at least one receiver 200 & 300 through respective receive antennas 210 & 310.

Additionally, the communication system includes an external transmit signal 440 generated by an external transmitter 400 coupled to an external antenna 420 that is transmitting to at least one of the receivers 200 & 300. In this system, the signal strength of transmit signal 140 should dominate the signal strength of the external transmit signal 440 when measured at least one of the receivers 200 & 300.

In one embodiment of the invention, the transmitter 100 is a jammer and the transmit signal 140 is a jamming signal that jams the external transmit signal 440 of external transmitter 400.

In another embodiment of the invention, the transmitter 100 is a MAS system and the transmit signal 140 is a MAS signal that dominates the external transmit signal 440 of external transmitter 400.

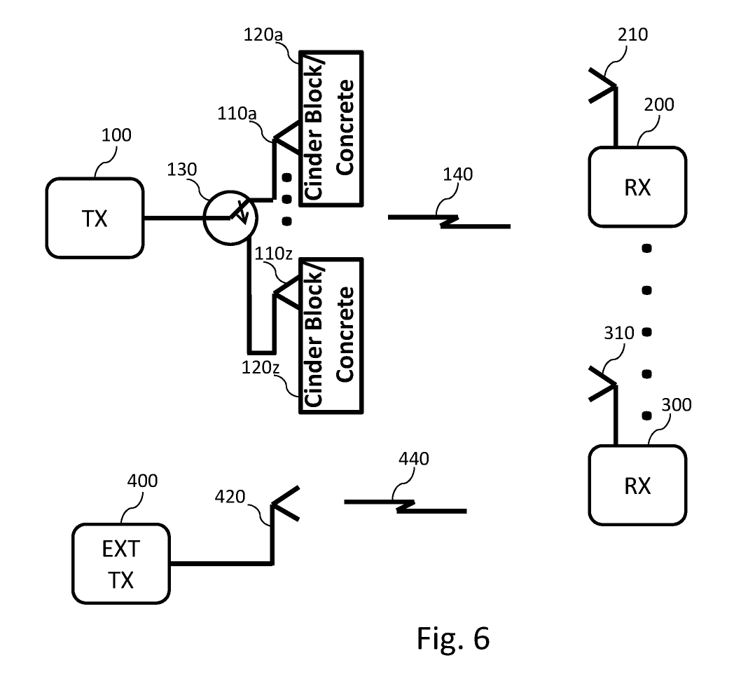

FIG. 6 shows a communication system comprising a transmitter 100 coupled to an RF element 130, which is further coupled to at least two antennas 110a & 110z. Each of the antennas 110a & 110z is respectively coupled to cinder block/concrete 120a & 120z for re-radiating the transmit signal 140. The transmit signal 140 is received by at least one receiver 200 & 300 through respective receive antennas 210 & 310.

The RF element 130 can be an RF switch which is switched periodically. Alternatively, RF element 130 can be an RF splitter that provides splitting of the RF signal to antennas 110a & 110z.

Additionally, the communication system includes an external transmit signal 440 generated by an external transmitter 400 coupled to an external antenna 420 that is transmitting to at least one of the receivers 200 & 300. In this system, the signal strength of transmit signal 140 should dominate the signal strength of the external transmit signal 440 when measured at least one of the receivers 200 & 300.

In one embodiment of the invention, the transmitter 100 is a jammer and the transmit signal 140 is a jamming signal that jams the external transmit signal 440 of external transmitter 400.

In another embodiment of the invention, the transmitter 100 is a MAS system and the transmit signal 140 is a MAS signal that dominates the external transmit signal 440 of external transmitter 400.

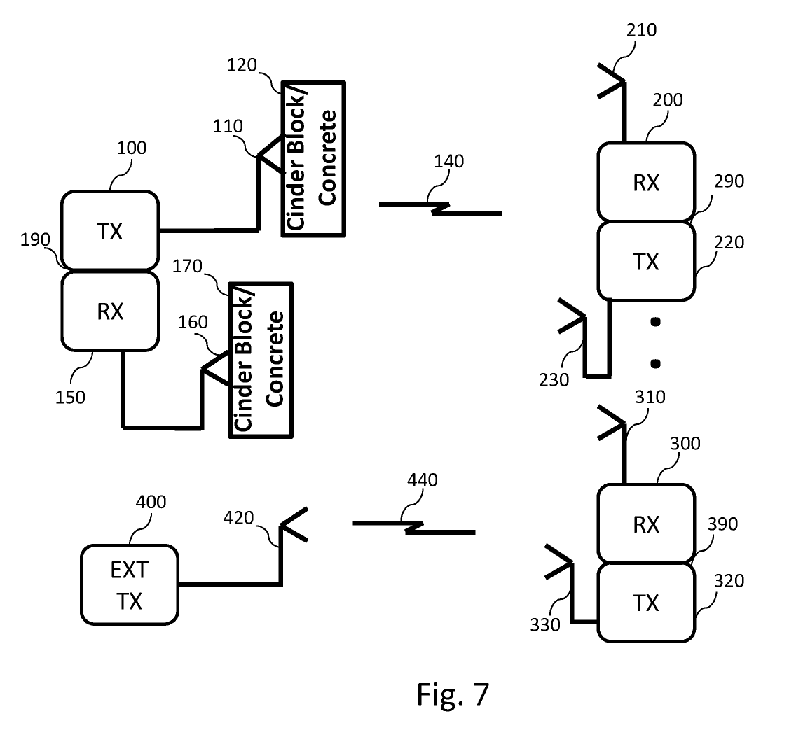

FIG. 7 shows a communication system comprising a first transceiver 190 with the associated transmitter 100 coupled to an antenna 110, which is further coupled to cinder block/concrete 120 (such as a cinder block/concrete wall) for re-radiating the transmit signal 140. The first transceiver 190 further includes a first receiver 150 coupled to a further antenna 160, which is further coupled to cinder block/concrete 170. The transmit signal 140 is received by at least one secondary transceiver 290 and 390. The secondary transceiver 290 and 390 include a respective secondary receiver 200 & 300 coupled to respective further antennas 210 & 310 to receive transmit signal 140. The secondary transceiver 290 and 390 further include a respective secondary transmitter 220 & 320 coupled to respective further antennas 230 & 330.

Additionally, the communication system includes an external transmit signal 440 generated by an external transmitter 400 coupled to an external antenna 420 that is transmitting to at least one of the receivers 200 & 300. In this system, the signal strength of transmit signal 140 should dominate the signal strength of the external transmit signal 440 when measured at least one of the receivers 200 & 300.

In one embodiment of the invention, the transmitter 100 is a jammer and the transmit signal 140 is a jamming signal that jams the external transmit signal 440 of external transmitter 400.

In another embodiment of the invention, the transmitter 100 is a MAS system and the transmit signal 140 is a MAS signal that dominates the external transmit signal 440 of external transmitter 400.

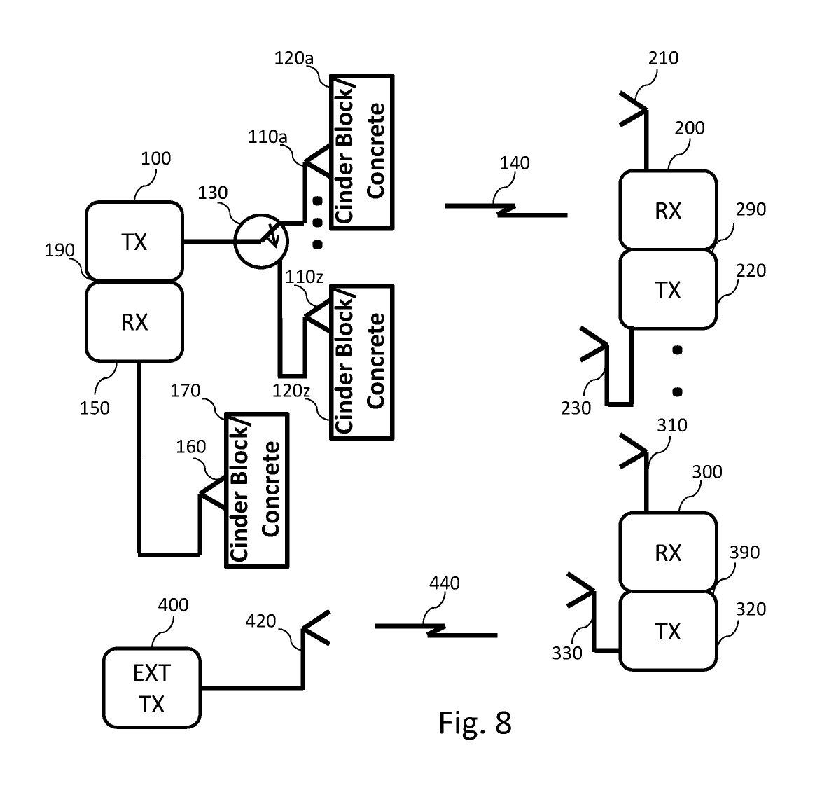

FIG. 8 shows a communication system comprising a first transceiver 190 with the associated transmitter 100 coupled to an RF element 130, which is further coupled to at least two antennas 110a & 110z. Each of the antennas 110a & 110z is respectively coupled to cinder block/concrete 120a & 120z for re-radiating the transmit signal 140. The first transceiver 190 further includes a first receiver 150 coupled to a further antenna 160, which is further coupled to cinder block/concrete 170. The transmit signal 140 is received by at least one secondary transceiver 290 and 390. The secondary transceiver 290 and 390 include a respective secondary receiver 200 & 300 coupled to respective further antennas 210 & 310 to receive transmit signal 140. The secondary transceiver 290 and 390 further include a respective secondary transmitter 220 & 320 coupled to respective further antennas 230 & 330.

The RF element 130 can be an RF switch which is switched periodically. Alternatively, RF element 130 can be an RF splitter that provides splitting of the RF signal to antennas 110a & 110z.

Additionally, the communication system includes an external transmit signal 440 generated by an external transmitter 400 coupled to an external antenna 420 that is transmitting to at least one of the receivers 200 & 300. In this system, the signal strength of transmit signal 140 should dominate the signal strength of the external transmit signal 440 when measured at least one of the receivers 200 & 300.

In one embodiment of the invention, the transmitter 100 is a jammer and the transmit signal 140 is a jamming signal that jams the external transmit signal 440 of external transmitter 400.

In another embodiment of the invention, the transmitter 100 is a MAS system and the transmit signal 140 is a MAS signal that dominates the external transmit signal 440 of external transmitter 400.

While the present invention has been shown and described with reference to a number of preferred embodiments, it is well known to those of skill in the art that the invention may be practiced otherwise than as specifically disclosed and claimed herein.

For example, although cinder block/concrete (such as a cinder block/concrete wall) has been described as the building material used to re-radiate, it is understood by those of ordinary skill in the art that the same technique can be used with building materials other than cinder block (e.g., concrete or other building materials instead of cinder block).

Likewise, although the use of cinder block/concrete has been shown on all of the antennas in the system in the Figures, it is well understood that the system can include any combination of use of cinder block/concrete to re-radiate with some antennas while not using cinder block/concrete with other antennas in the system.

Additionally, although some of the TX and RX antennas are shown as separate antennas, it is well known by those of the ordinary skill in the art that the same effect can be accomplished with a single antenna for TX and RX that uses a diplexer to separate signals.

What is claimed is:

1. A communication system comprising:
a transmitter; and
an antenna, which is further coupled to cinder block for re-radiating a transmit signal which is received by at least one receiver through a receive antenna.

2. A communication system according to claim 1, wherein an external transmit signal is transmitted by an external transmitter.

3. A communication system according to claim 1, wherein the transmitter is a jammer.

4. A communication system according to claim 2, wherein the transmitter is a jammer.

5. A communication system according to claim 2, wherein the transmitter is a part of a DAS system.

6. A communication system according to claim 2, wherein the transmit signal dominates the external transmit signal.

7. A communication system according to claim 2, wherein the transmit signal is a jamming signal.

8. A communication system according to claim 2, wherein the transmit signal is a MAS signal.

9. A communication system according to claim 1, further comprising:
a main receiver associated with the transmitter; and
a main receiver antenna coupled to the main receiver.

10. A communication system according to claim 9, wherein the main receive antenna is coupled to cinder block.

11. A communication system comprising:
a transmitter;
an RF element coupled to the antenna;
at least two antennas coupled to the RF element, each of the antennas respectively coupled to cinder block for re-radiating a transmit signal which is received by at least one receiver through a receive antenna.

12. A communication system according to claim 11, further comprising an external transmitter that transmits an external transmit signal.

13. A communication system according to claim 11, wherein the transmitter is a jammer.

14. A communication system according to claim 12, wherein the transmitter is a jammer.

15. A communication system according to claim 12, wherein the transmitter is a part of a DAS system.

16. A communication system according to claim 12, wherein the transmit signal dominates the external transmit signal.

17. A communication system according to claim 12, wherein the transmit signal is a jamming signal.

18. A communication system according to claim 12, wherein the transmit signal is a MAS signal.

19. A communication system according to claim 11, further comprising:
a main receiver associated with the transmitter; and
a main receiver antenna coupled to the main receiver.

20. A communication system according to claim 19, wherein the main receive antenna is coupled to cinder block.

21. A communication system according to claim 12, wherein the RF element is an RF switch.

22. A communication system according to claim 12, wherein the RF element is an RF splitter.

23. A communication system according to claim 19, wherein the main receive antenna is coupled to cinder block.

24. A communication system comprising:
a transmitter; and
an antenna, which is further coupled to a building material for re-radiating a transmit signal which is received by at least one receiver through a receive antenna.

25. A communication system according to claim 24, wherein the building material is cinder block.

26. A communication system according to claim 24, wherein the building material is concrete.

27. A communication system according to claim 24, wherein an external transmit signal is transmitted by an external transmitter.

28. A communication system according to claim 24, wherein the transmitter is a jammer.

29. A communication system according to claim 27, wherein the transmitter is a jammer.

30. A communication system according to claim 27, wherein the transmitter is a part of a DAS system.

31. A communication system according to claim 27, wherein the transmit signal dominates the external transmit signal.

32. A communication system according to claim 27, wherein the transmit signal is a jamming signal.

33. A communication system according to claim 27, wherein the transmit signal is a MAS signal.

34. A communication system according to claim 24, further comprising:
a main receiver associated with the transmitter; and
a main receiver antenna coupled to the main receiver.

35. A communication system according to claim 34, wherein the main receive antenna is coupled to cinder block.
